(19) United States
(12) Patent Application Publication
(10) Pub. No.: US 2026/0361601 A1
(43) Pub. Date: Nov. 12, 2026

(54) A VERSATILE NETWORK SYSTEM WITH SELF-REPAIRING CHARACTERISTIC

(71) Applicants: TURKCELL TEKNOLOJI ARASTIRMA VE GELISTIRME ANONIM SIRKETI, Istanbul (TR); TURKCELL ILETISIM HIZMETLERI ANONIM SIRKETI, Istanbul (TR)

(72) Inventors: Semih AKTAS, Istanbul (TR); Buse BILGIN, Istanbul (TR); Mehmet Izzet SAGLAM, Istanbul (TR)

(73) Assignees: TURKCELL TEKNOLOJI ARASTIRMA VE GELISTIRME ANONIM SIRKETI, Istanbul (TR); TURKCELL ILETISIM HIZMETLERI ANONIM SIRKETI, Istanbul (TR)

(21) Appl. No.: 19/491,587

(22) PCT Filed: Dec. 29, 2023
(86) PCT No.: PCT/TR2023/051878

§ 371 Date: Dec. 9, 2025

(30) Foreign Application Priority Data
Dec. 29, 2023 (TR) 2023/019812

(51) Int. Cl. H04L 41/08; H04L 41/0833; H04L 41/147; H04L 41/16; H04W 84/06

(52) U.S. Cl. CPC H04L 41/0886; H04L 41/0833; H04L 41/147; H04L 41/16; H04W 84/06

(57) ABSTRACT

The present invention relates to a versatile network system (1) which can repair itself and ensures continuity of communication by redesigning the network architecture when a terrestrial network is damaged, by using satellite communication and artificial intelligence-supported mobile network communication data.

### TECHNICAL FIELD

The present invention relates to a versatile network system which can repair itself and ensures continuity of communication by redesigning the network architecture when a terrestrial network is damaged, by using satellite communication and artificial intelligence-supported mobile network communication data.

### BACKGROUND OF THE INVENTION

Mobile network operators are telecommunications service providers who provide wireless voice and data communications for subscribed mobile users. Mobile network operators have a telecom infrastructure that enables the management and realization of mobile communications between subscribed mobile users and users on the same and external wireless and wired telecom networks. Mobile network operators enable mobile subscribers to use network services through their base stations.

The United States patent document no. U.S. Pat. No. 5,963,862A, an application included in the state of the art, discloses an integrated telecommunications system comprising at least one satellite in geo-synchronous orbit. The system includes a plurality of user terminals at fixed locations distributed over a geographical region and these terminals are provided by means of two-way user links by at least one satellite. Additionally, a satellite cellular telephone network includes a number whereby this telephone is associated with a user terminal. The system includes many gateway stations and network control centers and these stations enable to route the calls and to control satellite bandwidth and power. However, the United States patent document does not offer the possibility to perform an adaptive architecture optimization, nor does it have features to enable intelligent planning supported by artificial intelligence and to ensure that terrestrial and non-terrestrial network architectures behave in a mutually supportive manner.

The United States patent document no. U.S. Pat. No. 11,616,567B2, another application included in the state of the art, discloses a satellite communication method. A first network device obtains traffic of a set of satellite communication links or air interface resources allocated by the earth station to a set of satellite base stations and sends this information to a second network device. The information sent indicates that the traffic of a satellite communication link has reached a certain threshold or that the air interface resource of a satellite base station allocated by the ground station has reached a certain threshold. However, the United States patent document does not offer the possibility to perform an adaptive architecture optimization, nor does it have features that would enable the integration of terrestrial and non-terrestrial networks to improve the performance of the communication system, to perform intelligent planning supported by artificial intelligence, and to ensure that terrestrial and non-terrestrial network architectures behave in a mutually supportive manner.

The chinese patent document no. CN110493791B, another application included in the state of the art, discloses the architecture of an air-space-ground integrated network system based on a near space platform. The system includes many communication nodes and these communication nodes are determined as synchronous satellite, low orbit satellite, near space platform aircraft, ground station gateway, cloud center and 5G base station. These communication nodes are interconnected through different communication links and they provide a formula for calculating the switching speed of the network system architecture. However, the Chinese patent document does not offer the possibility to perform an adaptive architecture optimization, nor does it have features to enable artificial intelligence-supported intelligent planning and the mutually supportive behavior of terrestrial and non-terrestrial network architectures.

The Korean document KR20220066275A, an application included in the state of the art, discloses a method to separate a data plane from the control plane of 5G networks by using software-defined networking (SDN). The control plane is run on a low earth orbit (LEO) system and the LEO system is exclusively used to route the control plane. The LEO system creates and manages the path to the data plane. This network structure is specifically designed to enable 5G communications by using LEO satellites. However, the Korean patent document does not offer the possibility to perform an adaptive architecture optimization, nor does it have the features to enable artificial intelligence-supported intelligent planning and supportive behavior of terrestrial and non-terrestrial network architectures.

The Chinese patent document no. CN110099388B, another application included in the state of the art, discloses a satellite mobile communication system integrated with 5G network and detailed methods thereof. These methods include high-low frequency networks, spectrum sensing, Doppler frequency shift compensation, multi-user access and regional routing technologies. The patent provides methods for wireless communication in a dynamic spectrum environment in satellite-ground cooperation, high dynamic compensation for Doppler frequency shift in mobile satellite communication, realization of multi-user non-linear multiple access in mobile satellite communication environment, and realization of segmented routing technology based on SDN and NFV satellite network architectures. However, in the Chinese patent document, satellite communication is not designed for direct-to-phone management, but for sharing data in the control plane and it does not include an artificial intelligence-supported intelligent planning module.

### SUMMARY OF THE INVENTION

An objective of the present invention is to realize a system which can repair itself by integrating terrestrial and non-terrestrial grids and has a system architecture model developed by means of artificial intelligence models.

Another object of the invention is to realize a system which enables to update a network architecture by means of artificial artificial intelligence models that instantly respond to user demands and increase network efficiency; to automatically redesign a network architecture so as to maintain communication when terrestrial network components are damaged; and to report the updates made to the control center by means of explainable artificial intelligence and productive artificial intelligence models.

Another object of the invention is to realize a system which ensures uninterrupted communication-particularly during disasters and similar emergencies-by making a communication infrastructure more reliable, resilient and flexible.

### DETAILED DESCRIPTION OF THE INVENTION

“A Versatile Network System with Self-Repairing Characteristic” realized to fulfil the objective of the present invention is shown in the figures attached, in which:

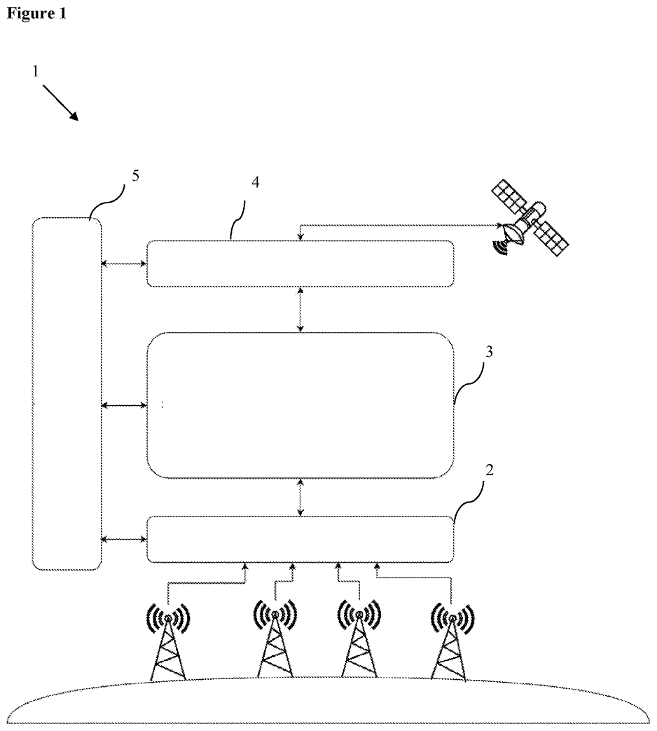

FIG. 1 is a schematic view of the inventive system.

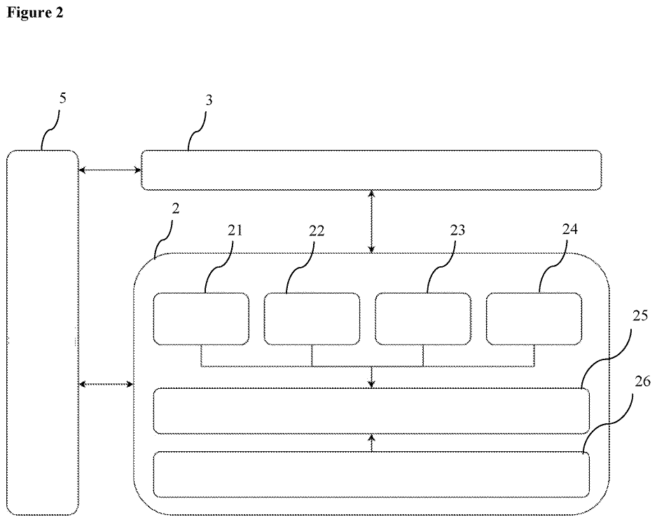

FIG. 2 is a view of a block diagram of the demand and authorization analysis server in the inventive system.

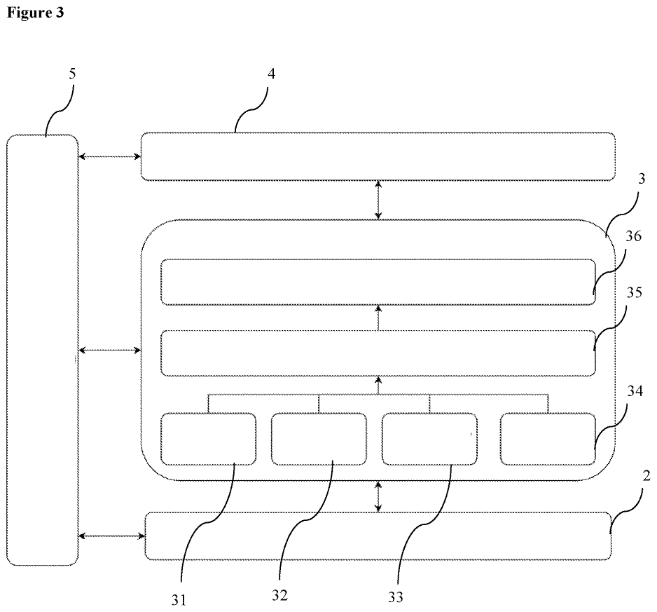

FIG. 3 is a view of a block diagram of the self-configuration server in the inventive system.

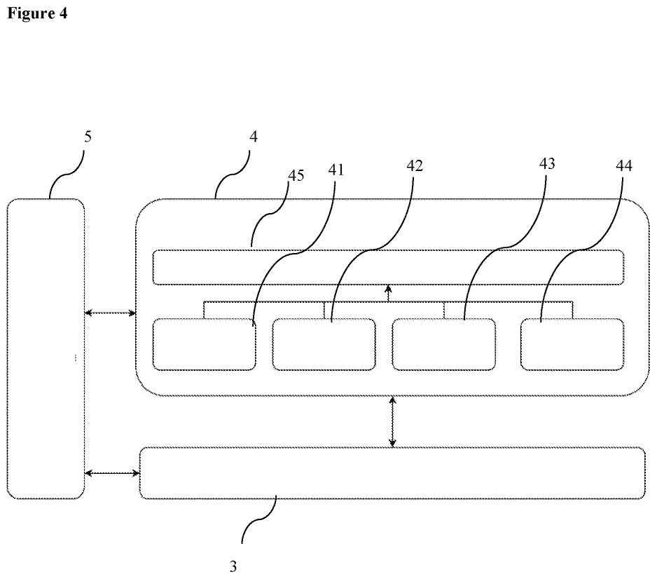

FIG. 4 is a view of a block diagram of the satellite communication server in the inventive system.

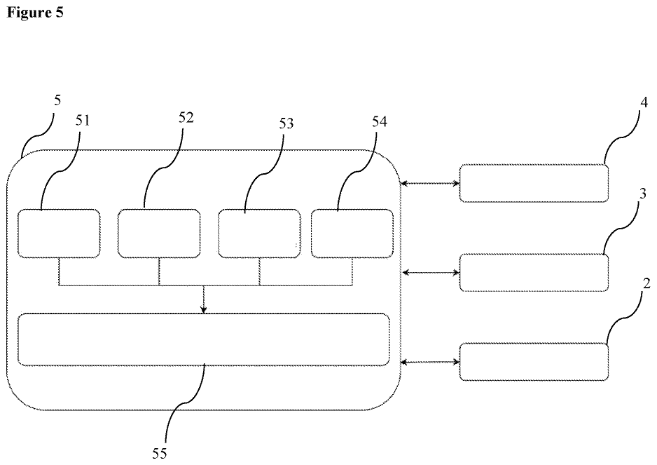

FIG. 5 is a view of a block diagram of the analysis server in the inventive system.

The components illustrated in the figures are individually numbered, where the numbers refer to the following:
1. System
2. Demand and authorization analysis server
   21. Demand forecasting module
   22. Authorization module
   23. Artificial intelligence needs assessment module
   24. Emergency requests monitoring module
   25. Demand and authorization module
   26. Data collection and analysis module
3. Self-configuration server
   31. Performance metrics monitoring and evaluation module
   32. Energy consumption assessment module
   33. Configuration management module
   34. Satellite emergency management module
   35. Smart configuration module
   36. Network integration module
4. Satellite communication server
   41. Satellite selection module
   42. Satellite communication protocol module
   43. Satellite capacity management module
   44. Satellite emergency management module
   45. Satellite communication and management module
5. Analysis server
   51. Decision explanation module
   52. Change reporting module
   53. Performance monitoring and reporting module
   54. Fault and issue tracking module

The inventive system (1) for redesigning the network architecture and maintaining the continuity of communication, when a terrestrial network is damaged, by integration of terrestrial and non-terrestrial networks; comprises
at least one demand and authorization analysis server (2) which is configured to improve network management, by taking into account factors such as user demands, network capacity and emergencies for network management and performance optimization;
at least one self-configuration server (3) which is configured to automate the management and configuration of network elements; to update the network configuration by taking into account energy consumption so that the network elements can operate dynamically; and to optimize the network structure;
at least one satellite communications server (4) which is configured to handle satellite communications and management; to integrate satellite communications elements with terrestrial network elements in order to optimize satellite communications; to select satellite systems; to configure communications protocols; to manage satellite capacity and to prioritize during emergencies;
at least one analytics server (5) which is configured to report on decisions taken and changes in a network configuration; to analyze actions taken using descriptive artificial intelligence and machine learning techniques; and to report to operators on network performance and decision processes.

The demand and authorization analysis server (2) which is configured to analyze user demands and to determine network needs included in the inventive system (1); comprises
at least one demand forecasting module (21) which is configured to analyze the impact of users, traffic and congestion on demands and to determine future communication needs in order to predict future communication demands;
at least one delegation module (22) which is configured to identify priority and critical communications elements and to prioritize low-priority requests such as social media live streams; to ensure effective use of network resources, particularly in emergencies;
at least one artificial intelligence needs assessment module (23) which is configured to analyze how artificial intelligence algorithms can be used for grid optimization and predicting future needs; and to optimize network configuration by using continuous learning models;
at least one emergency requests monitoring module (24) which is configured to collect and prioritize incoming requests during emergencies or special events; to identify emergency requests; and to reconfigure communications elements to best meet those requests;
at least one request and authorization determination module (25) which is configured to identify requests using information from other modules, assign authorizations; and to dynamically analyze requests and to perform authorization matching; and
at least one data collection and analysis module (26) which is configured to collect and analyze data on network performance and user demands; and to forecast future network needs by using data mining and analytical techniques.

The demand and authorization analysis server (2) included in the inventive system (1) is configured to analyze the current state of the network and to determine network performance metrics according to the needs of users. The demand and authorization analysis server (2) is configured to determine the needs of the network by using predictive artificial intelligence models; to prioritize emergency calls, especially in emergency situations such as disasters or terrorism; and to update the network architecture in order to maximize the service to be received by areas such as hospitals that need emergency calls. The demand forecasting module (21) is configured to determine future demand by using historical data and AI/ML models. In this way, metrics such as users' demands, traffic and density data are analyzed to determine future communication needs. The authorization module (22) is configured to identify priority and critical communication elements for efficient use of the network, especially in emergencies, and to automatically diagnose requests that fall behind in the priority category such as social media live broadcasts that increase data consumption. The artificial intelligence needs assessment module (23) is configured to analyze which artificial intelligence algorithms to use and in which ways to use them for network optimization and predicting future needs, and to run continuous learning models so that the structure continuously adapts itself. The emergency requests monitoring module (24) is configured to collect and prioritize incoming requests during emergencies or special events. The data collection and analysis module (26) is configured to collect and analyze data on network performance and user demands and to pull data from data sources in order to update performance metrics and predict future network needs using data mining and analytics techniques. The demand and authorization module (25) is configured to determine the network configuration to best meet the demands by analyzing the demands with information from the demand forecasting module (21), the authorization module (22), the artificial intelligence needs determination module (23), the emergency demands monitoring module (24) and the data collection and analysis module (26). The demand and authorization determination module (25) is configured to perform demand-authorization matching by using artificial intelligence to assign authorizations that are dynamic and capable of responding to different situations.

The self-configuration server (3) included in the inventive system (1) and configured to restructure the network elements and to optimize energy consumption in accordance with the determined needs determined by the demand and authorization analysis server (2); comprises
at least one performance metrics monitoring and evaluation module (31) which is configured to monitor network performance and to initiate automatic reconfiguration processes when it detects performance degradation;
at least one energy consumption assessment module (32) which is configured to update the network configuration to maximize energy efficiency and focus on energy efficiency;
at least one configuration management module (33) which is configured to automatically update the configurations of communication elements, to detect and manage changes such as the addition of new devices or the removal of existing devices;
at least one satellite emergency management module (34) which is configured to prioritize network configuration and to support emergency services during emergencies;
at least one smart configuration module (35) which is configured to automatically perform network configuration by combining information from modules with artificial intelligence; and
at least one network integration module (36) which is configured to regulate data flow by integrating terrestrial and non-terrestrial network elements.

The self-configuration server (3) included in the inventive system (1) is a dynamic configuration server in which terrestrial and non-terrestrial network elements are integrated with each other and the network architecture is designed. The self-configuration server (3) is configured to optimize energy consumption and automatically update the configurations of communication elements by taking into account the ever-changing conditions and usage needs of the network. The performance metrics monitoring and evaluation module (31) is configured to instantly monitor and evaluate network performance; continuously monitor performance metrics such as latency, bandwidth utilization, communication quality; and automatically initiate network reconfiguration when it detects performance degradation. The energy consumption assessment module (32) is configured to continuously review the network architecture and configurations to improve the energy efficiency of the network; to make energy efficiency-oriented updates; and to implement advanced configurations to minimize the energy consumption of communication elements. In this way, the network continuously optimizes energy use. The configuration management module (33) is configured to automatically update the configurations of the network elements. The configuration management module (33) is configured to quickly detect and manage changes such as the addition of new devices or the removal of existing devices; and to enable communication elements to operate more efficiently and dynamically. The emergency management integration module (34) is a module specifically responsible for the dynamic reconfiguration of the network during emergencies or outages. The emergency management integration module (34) is configured to immediately address priority communication needs from the demand and authorization analysis server (2) and to quickly reconfigure communication elements to support emergency services. The smart configuration module (35) is responsible for the dynamic configuration of the network by continuously processing data from the modules by using artificial intelligence methods. Based on the information it receives, the smart configuration module (35) responds instantly to the requirements of the network and automatically takes the necessary configuration decisions. The smart configuration module (35) transfers these assessments to the network integration module (36). The network integration module (36) integrates terrestrial and non-terrestrial network elements. The network integration module (36) rapidly coordinates any changes required to implement the updated network architecture. The network integration module (36) dynamically regulates and optimizes the communication flow by integrating different communication devices and components into the network. In this way, the network quickly adapts to constantly changing conditions and ensures maximum efficiency.

The satellite communication server (4) included in the inventive system and configured to integrate satellite communication elements with terrestrial network elements and to manage satellite systems, comprises
at least one satellite selection module (41) which is configured to select satellite systems and to organize the satellite architecture to provide the best communication performance by taking into account factors such as user demands, satellite locations, local conditions and weather;
at least one satellite communication protocol module (42) which is configured to manage satellite communication protocols and to configure features such as data transmission, security, error correction and bandwidth;
at least one satellite capacity management module (43) which is configured to manage satellite capacity and organize it in view of the need for high capacity;
at least one satellite emergency management module (44) which is configured to prioritize and to ensure continuity of satellite communications during emergencies; and
at least one satellite communication and management module (45) which is configured to provide satellite communication management based on requests and information from the modules by taking into account their communication needs.

The satellite communication server (4) included in the invenive system is the server responsible for satellite communication and management and integrates satellite communication elements with terrestrial network elements in line with the requests from the self-configuration server (3) and it enabling satellites to assume roles such as direct-to-phone and backhaul. The satellite selection module (41) is responsible for selecting the satellite systems to be used for satellite communications and organizing the satellite architecture. Satellite selection is configured to take into account user demands, local conditions and weather conditions to ensure the best communication performance. The satellite communication protocol module (42) is the module that manages the protocols to be used in satellite communication and includes satellite communication features such as data transmission, security, error correction and bandwidth and configures communication protocols. The satellite capacity management module (43) is responsible for organizing and managing satellite capacity with high efficiency and is responsible for managing satellite resources in the light of the capacity forecasts performed by the demand and entitlement assessment analysis server (2) and for increasing and optimizing capacity in case of peak demand. The satellite emergency management module (44) is responsible for prioritizing and managing satellite communications during emergencies or outages, directing the capacity reserved for emergency calls or disaster situations and ensuring the continuity and reliability of satellite communications. The satellite communication and management module (45) controls and analyzes all the acquired data.

The analysis server (5) included in the inventive system comprises
at least one decision explanation module (51) which is configured to explain the decisions made, to describe the decision processes and to produce understandable, as well as transparent, reports;
at least one change reporting module (52) which is configured to record changes to the system and to inform operators about updates and changes;
at least one performance monitoring and reporting module (53), which is configured to monitor network performance, generate reports, and continuously assess key performance indicators;
at least one fault and trouble monitoring module (54) which is configured to monitor faults and problems on the network, to generate fault and trouble reports, and to provide information to operators for rapid response; and
at least one update and improvement reporting module (55) which is configured to report updates and improvements made to the system and to provide information to operators and associated modules for future planning.

The analysis server (5) included in the inventive system is the module where decisions and architectural changes are reported and status reports are produced to mobile network operators and it is configured to analyze the actions taken with the help of Explainable (XAI) AI/ML techniques and to provide visual and written reports to operators by making network performance and decision processes understandable. The decision explanation module (51) generates explanations of the decisions taken with AI models, describing the causes and consequences of the decision processes and explaining the decisions in an understandable and transparent way for users. The change reporting module (52) reports changes to the system, records updates and changes made and provides operators with information on the latest status of the system. The performance monitoring and reporting module (53) monitors and reports on network performance, continuously monitors key performance indicators (KPIs) and provides operators with regular reports on network performance. The fault and problem monitoring module (54) monitors faults and problems on the network, detecting, recording and tracking faults and problems, and generating fault and problem reports for rapid response to operators. The update and enhancement reporting module (55) reports updates and enhancements to the system, explains the changes and enhancements made and provides operators with information for future planning.

The inventive system (1) submit information and approval comprising the principles of data privacy to the user and it operates within the scope of the Personal Data Protection Law (KVKK).

Within these basic concepts; it is possible to develop various embodiments of the inventive “Versatile Network System (1) with Self-Repairing Characteristic”; the invention cannot be limited to examples disclosed herein and it is essentially according to claims.

1. A system (1) for redesigning the network architecture and maintaining the continuity of communication, when a terrestrial network is damaged, by integration of terrestrial and non-terrestrial networks; characterized by
at least one demand and authorization analysis server (2) which is configured to improve network management, by taking into account factors such as user demands, network capacity and emergencies for network management and performance optimization;
at least one self-configuration server (3) which is configured to automate the management and configuration of network elements; to update the network configuration by taking into account energy consumption so that the network elements can operate dynamically; and to optimize the network structure;
at least one satellite communications server (4) which is configured to handle satellite communications and management; to integrate satellite communications elements with terrestrial network elements in order to optimize satellite communications; to select satellite systems; to configure communications protocols; to manage satellite capacity and to prioritize during emergencies;
at least one analytics server (5) which is configured to report on decisions taken and changes in a network configuration; to analyze actions taken using descriptive artificial intelligence and machine learning techniques; and to report to operators on network performance and decision processes.

2. A system (1) according to claim 1; characterized by the demand and authorization analysis server (2) which is configured to analyze user demands and to determine network needs included in the inventive system (1); comprising
at least one demand forecasting module (21) which is configured to analyze the impact of users, traffic and congestion on demands and to determine future communication needs in order to predict future communication demands;
at least one delegation module (22) which is configured to identify priority and critical communications elements and to prioritize low-priority requests such as social media live streams; to ensure effective use of network resources, particularly in emergencies;
at least one artificial intelligence needs assessment module (23) which is configured to analyze how artificial intelligence algorithms can be used for grid optimization and predicting future needs; and to optimize network configuration by using continuous learning models;
at least one emergency requests monitoring module (24) which is configured to collect and prioritize incoming requests during emergencies or special events; to identify emergency requests; and to reconfigure communications elements to best meet those requests;
at least one request and authorization determination module (25) which is configured to identify requests using information from other modules, assign authorizations; and to dynamically analyze requests and to perform authorization matching; and
at least one data collection and analysis module (26) which is configured to collect and analyze data on network performance and user demands; and to forecast future network needs by using data mining and analytical techniques.

3. A system (1) according to cliam 1; characterized by the demand and authorization analysis server (2) which is configured to analyze the current state of the network and to determine network performance metrics according to the needs of users.

4. A system (1) according to claim 1; characterized by the demand and authorization analysis server (2) which is configured to determine the needs of the network by using predictive artificial intelligence models; to prioritize emergency calls, especially in emergency situations such as disasters or terrorism; and to update the network architecture in order to maximize the service to be received by areas such as hospitals that need emergency calls.

5. A system (1) according to claim 1; characterized by the demand forecasting module (21) which is configured to determine future demand by using historical data and AI/ML models.

6. A system (1) according to claim 1; characterized by the demand and authorization analysis server (2) which is configured to identify priority and critical communication elements for efficient use of the network, especially in emergencies, and to automatically diagnose requests that fall behind in the priority category such as social media live broadcasts that increase data consumption.

7. A system (1) according to claim 1; characterized by the artificial intelligence needs assessment module (23) which is configured to analyze which artificial intelligence algorithms to use and in which ways to use them for network optimization and predicting future needs, and to run continuous learning models so that the structure continuously adapts itself.

8. A system (1) according to claim 1; characterized by the emergency requests monitoring module (24) which is configured to collect and prioritize incoming requests during emergencies or special events.

9. A system (1) according to claim characterized by the data collection and analysis module (26) which is configured to collect and analyze data on network performance and user demands and to pull data from data sources in order to update performance metrics and predict future network needs using data mining and analytics techniques.

10. A system (1) according to claim 1; characterized by the demand and authorization module (25) which is configured to perform demand-authorization matching by using artificial intelligence to assign authorizations that are dynamic and capable of responding to different situations.

11. A system (1) according to claim 1; characterized by the self-configuration server (3) which configured to restructure the network elements and to optimize energy consumption in accordance with the determined needs determined by the demand and authorization analysis server (2); comprising
at least one performance metrics monitoring and evaluation module (31) which is configured to monitor network performance and to initiate automatic reconfiguration processes when it detects performance degradation;
at least one energy consumption assessment module (32) which is configured to update the network configuration to maximize energy efficiency and focus on energy efficiency;
at least one configuration management module (33) which is configured to automatically update the configurations of communication elements, to detect and manage changes such as the addition of new devices or the removal of existing devices;
at least one satellite emergency management module (34) which is configured to prioritize network configuration and to support emergency services during emergencies;
at least one smart configuration module (35) which is configured to automatically perform network configuration by combining information from modules with artificial intelligence; and
at least one network integration module (36) which is configured to regulate data flow by integrating terrestrial and non-terrestrial network elements.

12. A system (1) according to claim 1; characterized by the self-configuration server (3) which is a dynamic configuration server in which terrestrial and non-terrestrial network elements are integrated with each other and the network architecture is designed.

13. A system (1) according to claim 1; characterized by the self-configuration server (3) which is configured to optimize energy consumption and automatically update the configurations of communication elements by taking into account the ever-changing conditions and usage needs of the network.

14. A system (1) according to claim 1; characterized by the performance metrics monitoring and evaluation module (31) which is configured to instantly monitor and evaluate network performance; continuously monitor performance metrics such as latency, bandwidth utilization, communication quality; and
automatically initiate network reconfiguration when it detects performance degradation.

15. A system (1) according to claim characterized by the energy consumption assessment module (32) which is configured to continuously review the network architecture and configurations to improve the energy efficiency of the network; to make energy efficiency-oriented updates; and to implement advanced configurations to minimize the energy consumption of communication elements. In this way, the network continuously optimizes energy use.

16. A system (1) according to claim 1; characterized by the configuration management module (33) which is configured to quickly detect and manage changes such as the addition of new devices or the removal of existing devices; and to enable communication elements to operate more efficiently and dynamically.

17. A system (1) according to claim 1; characterized by the emergency management integration module (34) which is is configured to immediately address priority communication needs from the demand and authorization analysis server (2) and to quickly reconfigure communication elements to support emergency services.

18. A system (1) according to claim 1; characterized by the satellite communication server (4) which is configured to integrate satellite communication elements with terrestrial network elements and to manage satellite systems; comprising
at least one satellite selection module (41) which is configured to select satellite systems and to organize the satellite architecture to provide the best communication performance by taking into account factors such as user demands, satellite locations, local conditions and weather;
at least one satellite communication protocol module (42) which is configured to manage satellite communication protocols and to configure features such as data transmission, security, error correction and bandwidth;
at least one satellite capacity management module (43) which is configured to manage satellite capacity and organize it in view of the need for high capacity;
at least one satellite emergency management module which is configured to prioritize and to ensure continuity of satellite communications during emergencies; and
at least one satellite communication and management module (45) which is configured to provide satellite communication management based on requests and information from the modules by taking into account their communication needs.

19. A system (1) according to claim 1; characterized by the analysis server (5) comprising
at least one decision explanation module (51) which is configured to explain the decisions made, to describe the decision processes and to produce understandable, as well as transparent, reports;
at least one change reporting module (52) which is configured to record changes to the system and to inform operators about updates and changes;
at least one performance monitoring and reporting module (53), which is configured to monitor network performance, generate reports, and continuously assess key performance indicators;
at least one fault and trouble monitoring module (54) which is configured to monitor faults and problems on the network, to generate fault and trouble reports, and to provide information to operators for rapid response; and
at least one update and improvement reporting module (55) which is configured to report updates and improvements made to the system and to provide information to operators and associated modules for future planning.

20. A system (1) according to claim 1; characterized by the analysis server (5) which is the module where decisions and architectural changes are reported and status reports are produced to mobile network operators and is configured to analyze the actions taken with the help of Explainable (XAI) AI/ML techniques and to provide visual and written reports to operators by making network performance and decision processes understandable.
